(19) United States
(12) Patent Application Publication
(10) Pub. No.: US 2016/0248260 A1
(43) Pub. Date: Aug. 25, 2016

(54) METHOD AND SYSTEM FOR FREQUENCY REGULATION

(71) Applicant: ENCYCLE CORPORATION, Toronto (CA)

(72) Inventors: Roman Peter KULYK, Toronto (CA); Mark Howard KERBEL, San Diego, CA (US)

(21) Appl. No.: 15/030,276

(22) PCT Filed: Oct. 23, 2014
(86) PCT No.: PCT/CA2014/000749

§ 371 Date: Apr. 18, 2016

Related U.S. Application Data
(60) Provisional application No. 61/894,530, filed on Oct. 23, 2013.

(51) Int. Cl. H02J 4/00

(52) U.S. Cl. CPC H02J 4/00

(57) ABSTRACT

A method for managing a group of energy consuming loads for frequency regulation is provided including a plurality of groups of loads, the method including: generating a set of load state data from each of the loads; generating a set of group of loads data from each of the group of loads; making an enablement state decision for each of the loads using the sets of load state data from the loads and the group of loads data from the groups of loads, wherein each of the enablement state decisions reflects an enablement state of a corresponding load in the group of loads, wherein the enablement state is either a load enabled state or a load disabled state.

### RELATED APPLICATIONS

This application claims the benefit of U.S. Provisional Application No. 61/894,530 filed Oct. 23, 2013, which is hereby incorporated by reference in its entirety.

### TECHNICAL FIELD

A method and apparatus for managing groups of energy consuming loads and for managing a group of energy consuming loads in a larger group of groups of energy consuming loads.

### BACKGROUND OF THE INVENTION

Energy is provided by suppliers to consumers in many forms and from many sources. Typical forms and sources of energy include electricity, natural gas, coal, oil, atomic energy etc.

Escalating energy costs and infrastructure costs have made managing both energy supply and energy consumption a critical issue which is important to both suppliers and consumers of energy.

From a supplier's perspective, both the energy consumption of consumers and the energy demand by consumers must be accommodated by the energy infrastructure. Energy consumption is the total amount of energy which is consumed over a time period, while energy demand is the rate at which the energy is consumed. Peak energy demand is the maximum rate at which energy is consumed. Energy consumption over a time period is a function of the energy demand over the time period.

An energy infrastructure must be capable of supplying the total amount of energy that is required by consumers and must also be capable of satisfying the peak demand for energy which is imposed upon the energy infrastructure.

In a typical energy supply system, the energy demand fluctuates over minutes, hours, days, weeks, months etc. Since energy consumption is a function of energy demand, an energy supply system in which energy consumption is relatively low may exhibit a relatively high peak energy demand if the energy demand fluctuates greatly, while an energy supply system in which energy consumption is relatively high may exhibit a relatively low peak energy demand if the energy demand fluctuates minimally.

An efficient energy supply system is a system in which the energy demand fluctuates minimally, since the energy infrastructure must be designed to satisfy the peak demand. As the fluctuation of the energy demand decreases, the peak energy demand for the energy supply system approaches the average energy demand on the energy supply system, which is the lowest peak energy demand which can be attained for the energy supply system. The energy demand on an energy supply system is therefore preferably managed so that the peak energy demand is minimized.

An energy supply system may provide energy to any number of consumers. The energy demand on an energy supply system may be managed on one level by managing the energy demands of the consumers who are connected with the energy supply system. The energy demand on an energy supply system may also be managed on a second level by managing the energy demands of the individual energy consuming loads which are connected with the energy supply system through the consumers.

In either case, managing the energy demand on the energy supply system involves distributing the energy demands of consumers and/or loads in order to avoid a large peak energy demand on the energy supply system. The distribution of energy demands may be accomplished by adjusting the times at which “discretionary loads” consume energy from the energy supply system.

A discretionary load is an energy consuming load which is not required to be operated rigidly according to a fixed schedule, or rigidly according to a fixed set of constraints such as temperature, humidity, etc., with the result that the time or times at which it consumes energy can be adjusted. Typically, a discretionary load has a duty cycle which is less than 100 percent, where duty cycle is defined as the percentage of time that the load must operate in order to satisfy its assigned objectives.

For example, if a heater must operate 50 percent of the time in order to maintain a desired temperature within a space, the duty cycle for the heater is 50 percent. If the heater isn't required to operate rigidly according to a fixed schedule, or rigidly within a fixed set of constraints while satisfying its duty cycle, the heater is also a discretionary load.

Some energy suppliers provide incentives or disincentives to consumers to assist in managing the energy demand on the energy supply system.

For example, in the case of an electrical system, suppliers may include in their billing both a “consumption charge” and a “peak demand charge”, particularly in the case of commercial, institutional and industrial consumers. The consumption charge is based upon the total amount of electricity consumed in the billing period (typically measured in kilowatt-hours, or “kWh”). The peak demand charge is often based upon the greatest amount of electricity used during a sustained fifteen minute period (typically measured in kilowatts, or “kW”).

The consumption charge compensates the supplier for the electricity which is consumed by a consumer. The peak demand charge compensates the supplier for the energy infrastructure which must be provided in order to accommodate the peak demand on the electrical system.

It may therefore be in the financial interest of a consumer to manage its energy demand in order to minimize the peak energy demand which is imposed by the consumer on the energy supply system.

Loads can use ancillary services (AS) to increase the available pool of flexible energy resources, support reliability, and reduce costs for all consumers. Examples of AS include frequency regulation and spinning reserve.

The almost instantaneous balance of supply and demand is the fundamental reliability criterion for an energy supply system. Imbalance causes the speed of the system (i.e. its frequency) to deviate, downwards for an undersupply and upwards for an oversupply. Conservation of energy requires that a supply-demand balance be maintained; and in an energy supply system, any imbalance is taken from, or given to, kinetic energy stored typically stored in synchronized rotating masses, such as generators, turbines, loads etc., that make up a synchronous energy supply system.

Such synchronous energy supply systems are typically designed to run around a nominal frequency of 60 Hz, with a small error margin of typically ±0.035 Hz in large systems, but the margin of error may be larger in some smaller systems, which usually have a relatively small synchronized rotating mass and consequently less stored energy. Therefore, the same imbalances in such smaller systems result in significantly larger frequency changes.

Therefore, frequency control (i.e., maintaining the system frequency within a tight range) is important in maintaining a reliable and secure energy supply system. Frequency control occurs over multiple time frames, requires supply and demand forecasting, and involves coordination among many different entities. In the longer term an energy supply system should be planned years in advance to ensure enough generation and corresponding transmission to meet demand as a basis of frequency control. Frequency control also requires that the energy suppliers and transmission are available and not undergoing maintenance. In a shorter time frame, for example a day-ahead, frequency control is planned for by scheduling generation and transmission, typically at an hourly resolution and in advance to meet forecasted demand. Within-the-hour generation can be dispatched every five minutes, for example, to provide that supply-demand balance is maintained. However, at the shortest time scales, automatic mechanisms are used to regulate the supply-demand balance and respond to imbalances like the sudden loss of a large generator. These automatic mechanisms are AS which respond reliably and quickly to maintain balance.

Spinning reserves are energy reserves available to serve the load immediately and that can respond directly to system frequency deviations or system operator commands. The response duration is typically about ten minutes, but may be over an hour for rare, serious events. Frequency regulation is adjusted continuously based on the automatic generation cycle (e.g., 2 to 8 seconds), and spinning reserve is usually called upon infrequently (e.g., from every few days to once a week or less).

Another alternative is to maintaining the supply-demand balance by using the load itself, however at present this type of load participation is involuntary and uncompensated and is typically used only as a last resort under unusual and rare circumstances. There has been some limited load participation in frequency control both in energy and AS aspects, and implementing controls on the load-side is growing, driven by improved and widely available communications systems.

Frequency regulation service is therefore the injection or withdrawal of real power by facilities capable of responding appropriately to a transmission system operator's automatic generator control (AGC) signal. When dispatched generation does not equal actual load plus losses on a moment-by-moment basis, the imbalance causes the grid's frequency to deviate from 60 Hertz, the standard in the U.S. (50 Hertz is used in other countries, but the same principles apply to any set frequency). When the energy supply system deviates from 60 Hz in the normal operation of the grid, frequency deviations outside an acceptable range negatively affect energy consuming devices and major deviations can cause generation and transmission equipment to disconnect from the grid, in the worst case leading to a cascading blackout.

Frequency regulation service can help to prevent these adverse consequences by rapidly correcting deviations in the transmission system's frequency to bring it within an acceptable range. The system operator calibrates the AGC signal sent to frequency regulation resources to respond to actual and anticipated frequency deviations or interchange power imbalance, both measured by area control error (ACE).

Frequency regulation is largely provided by energy generators (e.g., water, steam and combustion turbines) that are specially equipped for this purpose. Provision by other resources is emerging, as technologies develop, and tariff and market rules adapt to accommodate new resources. Such “regulation capable” generation, as well as storage devices and demand response resources, can respond automatically to signals sent by a Regional Transmission Organization (RTO) or an Independent System Operator (ISO), through AGC to increase or decrease real power injections or withdrawals and thereby correct actual or anticipated frequency deviations or interchange the scheduled imbalance, as measured by the ACE. The faster a resource can ramp up or down, the more accurately it can respond to the AGC signal and avoid overcompensating. Alternatively, when a resource ramps too slowly, its ramping limitations may cause it to work against the needs of the system and force the system operator to commit additional regulation resources to compensate.

Autonomous demand response/autonomous frequency regulation is defined as the load response to system-based signals rather than to master control signals like those provided by the AGC or price signals from a central dispatch center. The most readily available system based signal is frequency, which can be a very reliable indicator of grid instability, problems, or abnormal conditions. Speed governing systems at central generating stations, when operating in droop mode, employ frequency as the primary feedback signal. These governing systems are largely responsible for affecting primary frequency response of the bulk power grid thereby maintaining a continuous balance between supply and demand.

A utility or ISO or other similar entity typically provides a system wide signal (in the U.S. typically called an AGC signal) derived from the current state of the electrical grid or subsystem, or allows the use of system based signals directly, such as line frequency, for implementation of frequency regulation and control. In either case the result is intended to satisfy the short term imbalances that occur in the energy generation vs. the load being consumed (including losses) in the energy system. This is done by altering generation output or modifying the consumption of the power being produced. The required continuous rebalancing that is needed typically takes place at intervals as small as sub-seconds to as much as tens of seconds.

A challenge of implementing frequency regulation effectively is that many loads are not able to respond to changes in a control signal or system signal with enough speed and accuracy to make them effective resources on their own. This is typically due to constraints on the electrical load. For example, cycling a roof-top packaged air conditioning unit (RTU) more frequently than 10 minutes can shorten the life of the unit. As well, there is a quality of service issue in that if the load is curtailed or increased too much and too quickly, the task that the load is intended to fulfill may be impaired. For example, in the case of an RTU that is not cooling critical environments, a typical rise of more than 1-2 degrees Fahrenheit may not be acceptable. One implementation of frequency regulation aggregates these resources through a central system of software control, as described in U.S. Patent Application Publication No. 2013/0046895. This solution may have issues with reliability, a single point of failure, speed of computation, and other pitfalls of any command and control implementation.

Emergence is sometimes described with reference to “swarm” or “hive” behaviour whereby a group of simple devices, acting in a group, can exhibit behaviour which is seemingly more intelligent and complex than the simple behaviour programmed into the individual devices. Both multi-agent systems and emergence theory have been proposed for use in controlling complex environments, and systems have been developed for managing energy consuming loads within a group of energy consuming loads by using emergence, as described in U.S. Pat. Nos. 8,527,109; 8,527,108; 7,894,946; and 7,580,775. Typically, this group of loads is used to manage peak demands or implement demand response at, for example, a building (more accurately at the meter level that the utility uses to determine peak charges) and includes about four to fifty controlled loads. As indicated in the above patents, the loads communicate state information, then on the basis of that information, they each make a decision as to whether to curtail their load or allow it to run under its normal method of control (in the case of RTUs, this is typically thermostatic control).

### SUMMARY OF THE INVENTION

There remains a need for a decentralized method and/or system for managing frequency regulation allowing the loads to react timely, without loss of the ability to meet goals.

A method for managing a group of energy consuming loads for frequency regulation is provided including a plurality of groups of loads, the method including: generating a set of load state data from each of the loads in each of the groups of loads, wherein at least one of the loads in each of the group of loads is comprised of a discretionary load, wherein each of the loads in each of the group of loads has a duty cycle, and wherein the duty cycle for at least one of the discretionary loads in each group of loads is less than 100 percent; generating a set of group of loads data from each of the group of loads; making an enablement state decision for each of the loads using the sets of load state data from the loads and the group of loads data from the groups of loads, wherein each of the enablement state decisions reflects an enablement state of a corresponding load in the group of loads, wherein the enablement state is either a load enabled state or a load disabled state, wherein the load enabled state is a state where the corresponding load is capable of operating even when the corresponding load is not actually operating, and wherein the load disabled state is a state where the corresponding load is not capable of operating; and implementing the enablement state decisions.

The enablement state decisions may be made with a goal of achieving a frequency regulation for the groups of loads. The groups of loads may have a target frequency regulation and the enablement state decisions may be constrained by the variation caused by a load in a load enabled state or a load disabled state from the frequency regulation target.

The enablement state decisions for loads in a group of loads may be made in a decision making sequence. Each of the loads in a group of loads may have an impact on a level of frequency regulation for the group of loads and the decision making sequence may be dependent upon the impact on the level of frequency regulation.

The steps may be repeated in accordance with a schedule. The schedule may include at least one segment. The segment may include a plurality of sub-segments. One of the sub-segments may be used to receive load state data and groups of loads data. One of the sub-segments may be used to broadcast load state data and group of loads data. One of the-sub-segments may be used to make the enablement decision.

The set of group of loads data may include a time until the loads in the group of loads will make the enablement state decision.

A method for managing an energy consuming load for frequency regulation in a group of energy consuming loads is presented, including the load and a plurality of other loads, and comprising a plurality of groups of loads, the method including: receiving a set of load state data from the load, wherein the load is comprised of a discretionary load, wherein the load has a duty cycle and wherein the duty cycle for the load is less than 100 percent; receiving a set of group of loads data from each of the group of loads; compiling the set of load state data generated from the load with sets of load state data generated from the other loads and with sets of group of loads data generated from the groups of loads; making an enablement state decision for the load using the compiled sets of load state data and group of loads data, wherein the enablement state decision reflects an enablement state of the load, wherein the enablement state is either a load enabled state or a load disabled state, wherein the load enabled state is a state where the load is capable of operating even when the load is not actually operating, and wherein the load disabled state is a state where the load is not capable of operating; and implementing the enablement state decision for the load.

A method for managing a group of energy consuming loads for frequency regulation is present, including a plurality of groups of loads, the method including: generating a set of load state data from each of the loads in each of the groups of loads, wherein at least one of the loads in the group of loads is comprised of a discretionary load, wherein each of the loads in the group of loads has a duty cycle, and wherein the duty cycle for at least one of the discretionary loads is less than 100 percent; generating a set of group of loads data from each of the group of loads; making an enablement state decision for each of the loads using the sets of load state data from the loads and the set of group of loads data from the groups of loads, wherein each of the enablement state decisions reflects an enablement state of a corresponding load in a group of loads and a state of a group of loads from the plurality of groups of loads, wherein the enablement state is either a load enabled state or a load disabled state, wherein the load enabled state is a state where the corresponding load is capable of operating even when the corresponding load is not actually operating, and wherein the load disabled state is a state where the corresponding load is not capable of operating; and implementing the enablement state decisions.

A computer readable nontransitory medium providing computer readable instructions for directing a processor to make an enablement state decision reflecting an enablement state of an energy consuming load in a group of energy consuming loads comprising the load and a plurality of other loads is provided, the group of loads in a plurality of groups of loads, wherein the enablement state is either a load enabled state or a load disabled state, wherein the load enabled state is a state where the load is capable of operating even when the load is not actually operating, and wherein the load disabled state is a state where the load is not capable of operating, the instructions including: generating a set of load state data from the load; generating a set of group of loads state data from the group of loads; compiling the set of load state data from the load with sets of load state data from the other loads and with the set of group of loads data and with the other groups of loads; and processing the compiled sets of load state data in order to make the enablement state decision.

A computer program product is provided including computer readable instructions for directing a processor to make an enablement state decision reflecting an enablement state of an energy consuming load in a group of energy consuming loads comprising the load and a plurality of other loads, the group of loads in a plurality of groups of loads, wherein the enablement state is either a load enabled state or a load disabled state, wherein the load enabled state is a state where the load is capable of operating even when the load is not actually operating, and wherein the load disabled state is a state where the load is not capable of operating, the instructions including: generating a set of load state data from the load; generating a set of group of loads state data from the group of loads; compiling the set of load state data from the load with sets of load state data from the other loads and with the set of group of loads data and with the other groups of loads; and processing the compiled sets of load state data in order to make the enablement state decision.

A controller of an electrical load is provided, the load within a group of loads, the group of loads within a group of groups of loads, the controller configured to make an enablement decision regarding the load based on a set of data received relating to the state of a plurality of loads with the group of loads, and a set of data received relating to the other groups of loads; the enablement decision including an assessment of the impact of the load on a target frequency regulation.

In its various aspects, the invention provides methods, apparatus, computer readable media and systems for use in managing one or more energy consuming loads in a group of groups of energy consuming loads. The invention is based upon principles of emergence theory. As a result, the invention enables one or more loads in a group of loads, the group of loads within a group of groups of loads, to operate independently, without negotiation amongst the loads, but using fundamental rules of behaviour which independently govern each of the loads.

### BRIEF DESCRIPTION OF DRAWINGS

Embodiments of the invention will now be described with reference to the accompanying drawings.

FIG. 1 is a block diagram depicting an embodiment of a load group of groups according to the invention.

FIG. 2 is a block diagram depicting an embodiment of a frequency regulation system according to the invention.

FIG. 3 is a flow chart depicting an embodiment of a method of adjusting and displaying a controller duty cycle ratio.

FIG. 4 is a flow chart depicting an embodiment of a method of coordinating time synchronization amongst controllers.

FIG. 5 is a flow chart depicting an embodiment of a method of computing and broadcasting frequency group state.

FIG. 6 is a flow chart depicting an embodiment of a method of computing and broadcasting load state information.

FIG. 7 is a flow chart depicting an embodiment of a method of enabling decisions for a load within a group.

FIG. 8 is a flow chart depicting an embodiment of a method by which a load group within a frequency regulation group makes a decision.

FIG. 9 is a flow chart depicting an embodiment of a process by which load enablement decisions are reached.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The algorithms and displays with the applications described herein are not inherently related to any particular computer or other apparatus operative in controller. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise. The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way the scope of the disclosed invention(s). An Abstract has been included in this application merely because an Abstract of not more than 150 words is required under 37 C.F.R. section 1.72(b) and corresponding statutes in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems, techniques, processes, methods or algorithms. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented, for example, which may be present on a controller. Although not required, embodiments will be described in the general context of computer-executable instructions, such as program applications, modules, objects or macros being executed by a computer. Those skilled in the relevant art will appreciate that the invention can be practiced with other computer configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments, such as a cloud, where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

The computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft. The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links. While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter. The computer can include other output devices, such as speakers, printers, etc.

### Embodiments of the Invention

The system and method according to the invention allows a group of groups to achieve behavior that cannot be accomplished by a single group acting independently. In the case of frequency regulation, a constraint is a measurable “load” following a signal providing operating parameters (which may include parameters such as ramp rate, delay time. etc.). This signal may change frequently (for example, every few seconds), which is far more frequently than most individual loads can adapt. For example, in the case of HVAC loads, modulation may only happen at most every approximately 10 minutes. In order to achieve both goals of load management and frequency regulation, an aggregation of a group of groups of loads is provided, each group of loads operating with its segment start offset slightly from the other groups. In this way, frequency regulation that meets the tight constraints required can be implemented.

If the loads in a building (an example of a group of loads) are viewed in aggregate, they can be considered as a single individual controllable virtual load having characteristics that can be self-managed (by respecting parameters such as the duty cycle), or that can be monitored for parameters such as power consumption, need, the state of the loads etc. To meet the stringent restrictions on performance dictated by frequency regulation (requiring response within a specific time interval following the AGC signal), the decisions that the virtual loads make have to be dispersed over time.

An embodiment of the system according to the invention allows groups of loads, for example in buildings to communicate with other groups of loads so that each group of loads, also referred to as a virtual load, can communicate its state to all virtual loads, with a view that each virtual load can make a decision that will introduce small and simple perturbations to its algorithm (through independent decision making) that have an overall effect of following the AGC signal. From the perspective of the individual virtual load, it simply propagates additional state information amongst the participating loads in the group to allow the loads to subtly modify their decision process.

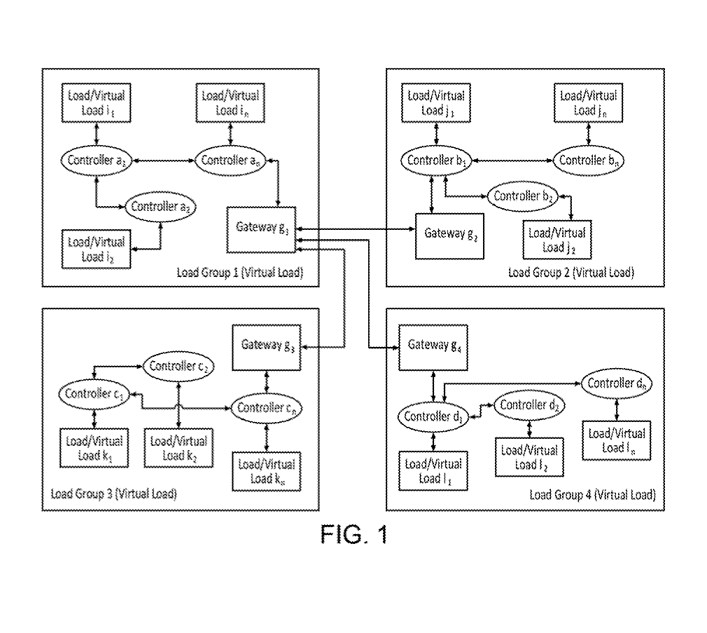

With reference to FIG. 1, an embodiment of a collection of load groups 1 to 4 is shown. Each load group 1 to 4 is a collection of controllers a to d, and each controller is in communication with a load or a virtual load designated as i to l. A load is a physical device that consumes energy. A virtual load is an aggregation of devices that consume energy and/or other virtual loads. For example load group 1, includes loads/virtual loads i₁ . . . iₙ. Each virtual node is connected to a corresponding controller a₁ . . . aₙ. At least one controller, in this case controller aₙ, is in contact with gateway g₁, which in turn is in communication with gateways g₂ to g₄ of other load groups 2 to 4.

A frequency regulation group according to the invention is a collection of load groups as shown in FIG. 1. Load groups 1 to 4 communicate with other frequency regulation group peers via gateways g₁ to g₄, each of which is connected to at least one controller a to d, within the corresponding load group. While four load groups are shown in FIG. 1, more or less may be present. Similarly each load group may include any number of loads/virtual loads and corresponding controllers.

Gateways g₁ to g₄ manage communications between the load groups and distribute information received from the other gateways to at least one corresponding controller within the load group. Gateways g₁ to g₄ include a processor and transceivers to receive and transmit information from other gateways or controllers and to controllers of other gateways.

Controllers a to d may be adapted or configured to be compatible with the particular load or other load to which it is connected or with which it is associated. However, preferably, the components and configuration of each controller is substantially similar and operates in a substantially similar manner. Thus, the following description of a controller for connection with the load is also applicable with respect to any additional controllers provided for managing the plurality of other loads in the group of loads within the energy supply system.

The controller typically includes a transmitter configured to transmit a set of load state data generated from the load and a receiver configured to receive sets of load state data generated from the other loads. Although a separate transmitter and receiver may be provided, in the preferred embodiment, the transmitter and receiver may include a single transceiver. Any type or configuration of transceiver capable of, and suitable for, transmitting and receiving the necessary load state data may be utilized. The transceiver may be a wireless transceiver. More particularly, the transceiver may include a radio frequency wireless transceiver associated with an antenna for transmitting and receiving the load state data. The wireless transceiver may operate in accordance with any suitable or compatible communication protocol. The wireless transceiver may be configured to comply substantially with an IEEE 802.15.4 standard. For example, a ZigBee™ compliant 2.4 GHz wireless platform may be utilized. ZigBee™ is a trade-mark of the ZigBee Alliance.

Further, the controller includes a processor configured to generate the set of load state data from the load, to compile the sets of load state data from the group of loads, and group of groups of loads, and to process the compiled sets of load state data in order to make an enablement state decision for the load.

Thus, the processor is associated or connected with the transceiver such that the processor may communicate with the other controllers. Specifically, the processor generates the set of load state data from the load for transmission by the transceiver to the other controllers. Further, the processor compiles the sets of load state data received by the transceiver from the other apparatuses. The processor then utilizes the compiled sets of load state data from the group of loads in order to make an enablement state decision for the load.

Accordingly the processor is programmed to perform its functions, and specifically to generate the set of load state data from the load, to compile the set of load state data from the load with sets of load state data from the other loads and to process the compiled sets of load state data in order to make an enablement state decision for the load independently of the other loads. As indicated, the enablement state decision reflects an enablement state of the load, wherein the enablement state is either a load enabled state or a load disabled state. The load enabled state is a state in which the load is capable of operating, while the load disabled state is a state in which the load is not capable of operating.

The controller may further include any mechanism or device capable of implementing the enablement state decision, including a control circuit and a switch. The control circuit and the switch are associated with the processor for receiving the enablement state decision therefrom. Further, as described in detail below, the switch is actuatable between an open state and a closed state in order to implement the enablement state decision.

Any type of control circuit and compatible switch may be used which are capable of implementing the enablement state decision. The control circuit and the switch are compatible for use with one or both of an energization circuit for controlling an energization-controllable load, and a control line circuit for controlling a control line-controllable load. The controller is capable of use with both an energization circuit and a control line circuit such that the controller is compatible for use in controlling either an energization-controllable load or a control line-controllable load. The control circuit may include a transistor array such as a Darlington transistor, often referred to as a Darlington pair. The switch is typically a relay switch such as a Double-Pole Double- Throw relay capable of handling 15 Amperes of load. One of the relay poles is provided for use with an energization-controllable load, while the other of the relay poles is provided for use with a control line-controllable load. Alternatively, the switch may include a Single-Pole Single-Throw relay in which a single pole may be used for either an energization-controllable load or a control line-controllable load.

The controller is connected within an energization circuit between the load and an electrical energy source, such as a power supply or outlet. More particularly, the switch is connected within the energization circuit and is actuatable between an open state and a closed state in order to implement the enablement state decision. Specifically, the switch is actuated to the closed state so that the energization circuit is closed when the load is desired to be in the load enabled state. Conversely, the switch is actuated to the open state so that the energization circuit is opened when the load is desired to be in the load disabled state.

The controller may operate in monitoring mode in which it monitors the load only and transmits load state data generated from the load to the other controllers. Typically, the monitoring mode is utilized for non-discretionary or “must-run” loads, such as lighting systems or CO₂ exhaust fans.

The controller may further include a sensor device for sensing the energy demand of the load. The electrical energy sensor device may include at least one current sensor and an associated rectifier or rectifier circuit

The controller may additionally include a device for adjusting a duty cycle of the load. The duty cycle of the load is the percentage of time that the load must operate in order to satisfy its assigned objectives. A natural duty cycle defines the percentage of time that the load must operate within its environment to provide a particular result or to achieve a particular objective. However, if desired, the load may be assigned a duty cycle. An assigned duty cycle may be either more or less that the natural duty cycle of the load. The adjusting device may be used where desired to adjust the duty cycle of the load for any reason, including providing an assigned duty cycle. Any device may be used which is capable of adjusting the duty cycle

The processor may be programmed to perform a set of instructions permitting the processor to perform one or more of its functions as described herein. The set of instructions permits the processor to perform the functions necessary to make the enablement state decision for the load, independently of the other loads. In other words, in the enablement state decision for the load is made taking into consideration the sets of load state data from the other loads and virtual loads, but is made independently of the enablement state decisions made for the other loads and virtual loads. Further, the processor is also programmed to direct the controller to implement the enablement state decision for the load.

In all aspects of the invention, the load or at least one of the loads in a group of loads is a discretionary load. Each of the loads in a group of loads may be either a non-discretionary load or a discretionary load. A non-discretionary load is a load which must always be in an enabled state, which must be enabled rigidly according to a schedule, which must be enabled rigidly according to a set of constraints, or which must always be available to be enabled when called upon. A load in the monitoring mode, as discussed above, is also considered to be a non-discretionary load. A discretionary load is a load for which there is some flexibility in operating within a schedule or within a set of constraints, as long as the load is capable of achieving its duty cycle. Further, as discussed above, the load and each of the other loads has a duty cycle. In the preferred embodiment, the duty cycle for at least one of the discretionary loads is less than 100 percent. Thus, the duty cycle may be less than 100 percent for the load and/or at least one of the other loads or virtual loads. The duty cycle is the percentage of time that the load must operate in order to satisfy its assigned objectives. Thus, the load must operate less than 100 percent of the time to satisfy its assigned objectives.

The enablement need of each load relates to the “urgency” of the need for that load to be placed in the load enabled state. Although the enablement need or urgency may be based upon a number of factors, typically the enablement need is based upon an amount of time in which that load has been in the load enabled state, upon an amount of time remaining for that load to achieve its duty cycle, and upon the duty cycle of that load. Thus, for example, the enablement need will be more urgent where a load is at risk of not achieving its duty cycle.

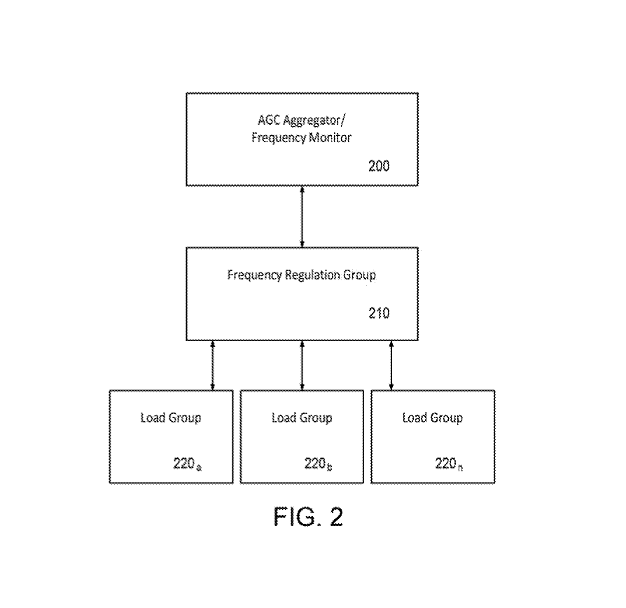

With reference to FIG. 2, groups of loads or load groups 220ₐ, 220_{b} to 220ₙ, can be grouped to operate as a frequency regulation group 210. Frequency regulation group 210 communicates with AGC Aggregator or Frequency Monitor 200 to receive a frequency regulation signal, which is used by load groups 220 as explained below, and to send meter and other data to a monitoring party. While three load groups 220ₐ, 220_{b} to 220ₙ are shown, more or less may be present in a frequency regulation group.

The method of controlling the frequency regulation group is based on the existing system state information (including that of all loads in the group), and that each controller decides whether to enable or disable the load that it is controlling, and to potentially override that decision based on an additional control input, where such decisions are made to simultaneously optimize the function of multiple competing objectives. This applies to controllers a₁ to aₙ within a group (e.g. load group 1 in FIG. 1), or, as shown in FIG. 2, groups 220ₐ, 220_{b} within a group of groups 210 (a group of groups of loads is referred to herein as a “frequency regulation group”):

Controllers within a load group as shown in FIG. 1 (as an example, each load controller may be in communication with electrical loads in a building), employ the above method to optimize the group's (e.g. the building's) peak demand for energy by reducing peak demand.

Groups of controllers within a frequency regulation group (e.g. groups of buildings operating together for frequency regulation purposes) employ a strategy to optimize the groups' ability to match a frequency regulation signal. Modifications to the controller decisions allow loads to meet both building peak management and overall frequency regulation goals.

There is no limit to the aggregation of frequency regulation groups, given that groups of groups can be aggregated into higher-level constructs for grid management applications.

The method according to the invention manages the behaviour of each controller and controls all functionality including: communications with other controllers; acquisition of information from the load being controlled or monitored; control of the relay for load enablement or disablement; adjustment and display of duty cycle; dissemination of state information to other controllers in the group; acquisition of state information from other controllers in the group; and time sequencing and synchronization.

A single controller acting on its own is too simple to accomplish the above functions. However, in a group, acting cooperatively, the controllers exhibit behavior which has the effect of reducing the peak electrical aggregate demand for the loads under the control of the group. This can be likened to a group of ants in an ant colony, where a single ant does not exhibit very complex behavior, performing simple functions like foraging, garbage removal, protection and maintenance of the colony. However, in the aggregate, each colony has distinctive higher level characteristics such as territoriality, aggression, etc., without any means of central control of the colony.

The system and method according to the invention provides for a simple process that in a group results in the desired effect of lowering the system peak electrical demand and managing frequency. The controllers include a number of “concurrently” running processes (there are dependencies between some of them), including:
a. Duty Cycle Display and Adjustment;
b. Time Synchronization;
c. Computation and Broadcast of State Information; and
d. Controller Load Enablement Decision.

The analogous counterpart of a controller within a load group is a load group within a frequency regulation group, i.e. a group of groups operating together to implement frequency regulation.

In a frequency regulation group, each load group communicates its state information to the group of load groups. This state information includes frequency regulation state/parameters and the calculation of a node's need. A controller bases its ‘need’ on the amount of time it requires in order to fulfill its duty cycle, with controllers of higher needs considered first for enablement candidates. A load group bases its ‘need’ on the proximity to its next time pulse (i.e. the time when its controllers will next make decisions), with the load group closest to (but not past) its next time pulse being considered first as the next frequency regulation candidate.

The load group's decision process deals with the frequency regulation group's target and current fulfillment, and incorporates frequency regulation considerations: If the load group implements an adjustment in order to meet a frequency regulation signal, then:
a. For a ‘regulation up’ adjustment, the last (few) loads that typically would have been enabled are disabled.
b. For a ‘regulation down’ adjustment, the last (few) loads that typically would have been disabled are enabled.

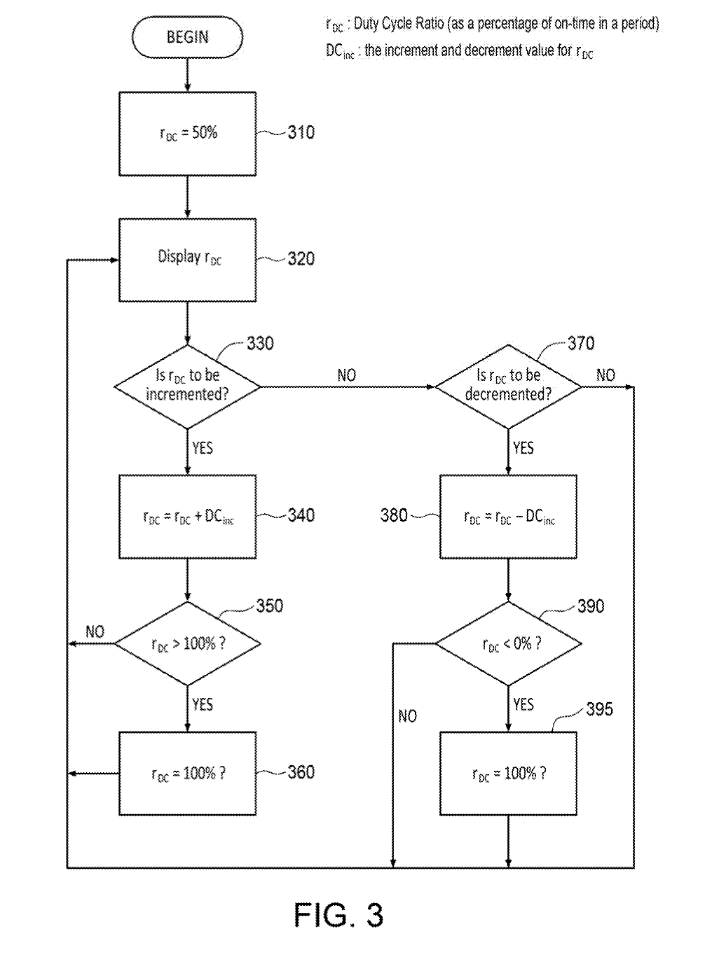

Referring to FIG. 3, a set of instructions or an algorithm is provided for adjusting and displaying a controller duty cycle. This system begins by establishing a value for r_{dc} (at step 310), which is the duty cycle ratio expressed as a percentage of on-time for the controlled load within a timer period. As shown in FIG. 3 this value may be set at 50%, although other values may be selected. The value is displayed (step 320). The controller then determines if r_{dc} is to be incremented (at step 330). If so, r_{dc} is increased by the addition of an increment value, DC_{inc} (step 340). If the new value is determined not to be greater than 100% (step 350), the new value is displayed (step 320) and the process repeats. If the new value of r_{dc} is greater than 100% it is reduced to 100% (step 360) and then displayed (step 320) and the process repeated.

If r_{dc} is not to be incremented, the controller determines if r_{dc} is to be decremented (step 370). If not, the value of r_{dc} is not changed, and is displayed (step 320) after which the process repeats. If r_{dc} is to be decremented, it is reduced by DC_{inc} (step 380). The controller determines if this value is less than 0% (step 390). If the value of r_{dc} is less than 0% it is increased to 0% (step 395), and displayed (step 320) before repeating the process. If the value of r_{dc} is not less than 0% it is displayed (step 320) and the process repeated.

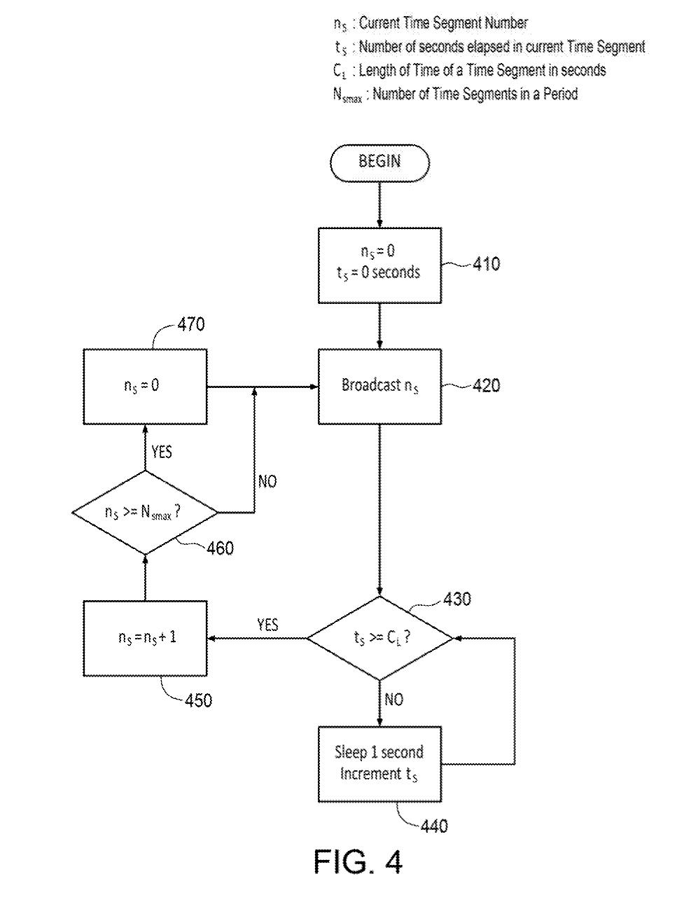

Within a group, or group of groups including several controllers, one controller (for example the first controller active) is selected to perform a time-keeping function. Periodically, this controller broadcasts a timing pulse which will be used by all controllers/groups to co-ordinate efforts. Typical periods are 1 or 2 hours, with 10-20 segments per period (corresponding to 1-10 minutes per segment). A time pulse is broadcast at the start of every new segment. A set of instructions or an algorithm is provided in FIG. 4 for coordinating time synchronization.

The process begins by setting the current time segment number (nₛ) to 0 and the number of seconds elapsed in the current time segment (tₛ) to 0 seconds (step 410). The value of nₛ is then broadcast to other controllers and groups (step 420). The controller then determines if the value of tₛ is greater or equal to the length of time of the time segment (C_{L}) (step 430). If not, the controller waits or sleeps for a second, and increments tₛ accordingly (step 440) before comparing the new value of tₛ to C_{L} (step 430).

If tₛ is greater than or equal to C_{L}, ns is increased by one (step 450). nₛ is then compared to the number of time segments available in a period (Nₛₘₐₓ) (step 460). If nₛ is greater than or equal to Nₛₘₐₓ, ns is set to 0 (step 470) and then broadcast (step 420). If not, the current value of nₛ is broadcast (step 420) without change.

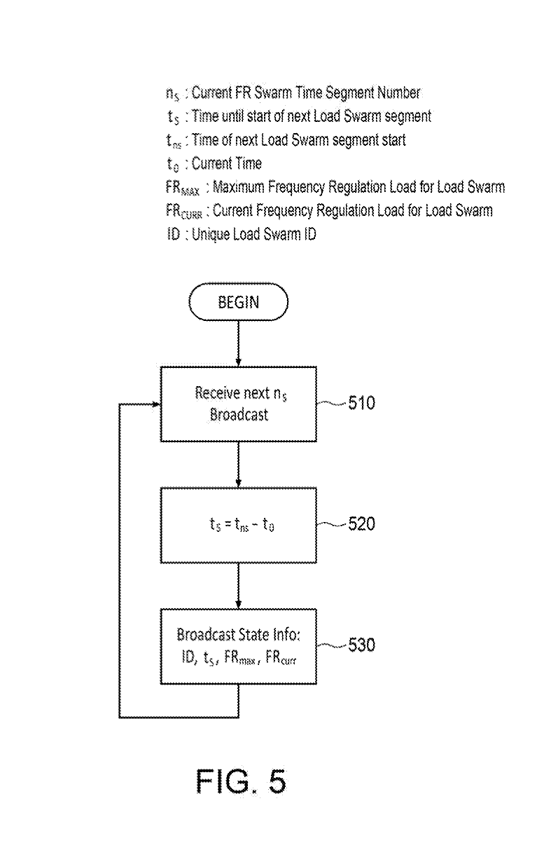

At the start of each time segment, each load group in the frequency regulation group takes stock of its current state, and broadcasts this information to all other load groups in the frequency group. FIG. 5 displays a set of instructions or an algorithm by which this broadcasting may take place.

The process begins by the group receiving the starting (i.e. current) frequency regulation group segment number (nₛ) broadcast (step 510). The time until the start of the next load group segment (tₛ) is then set to the time of the next load group segment start (tₙₛ) less the current time (t₀) (step 520). The group then broadcasts its state information (step 530), including its unique load group ID (ID); tₛ, the maximum frequency regulation load for the load group (FRₘₐₓ) and the current frequency regulation load for the load group (FR_{curr}). The process then returns to receive the next nₛ broadcast (step 510). This broadcast information is subsequently used by the frequency regulation group.

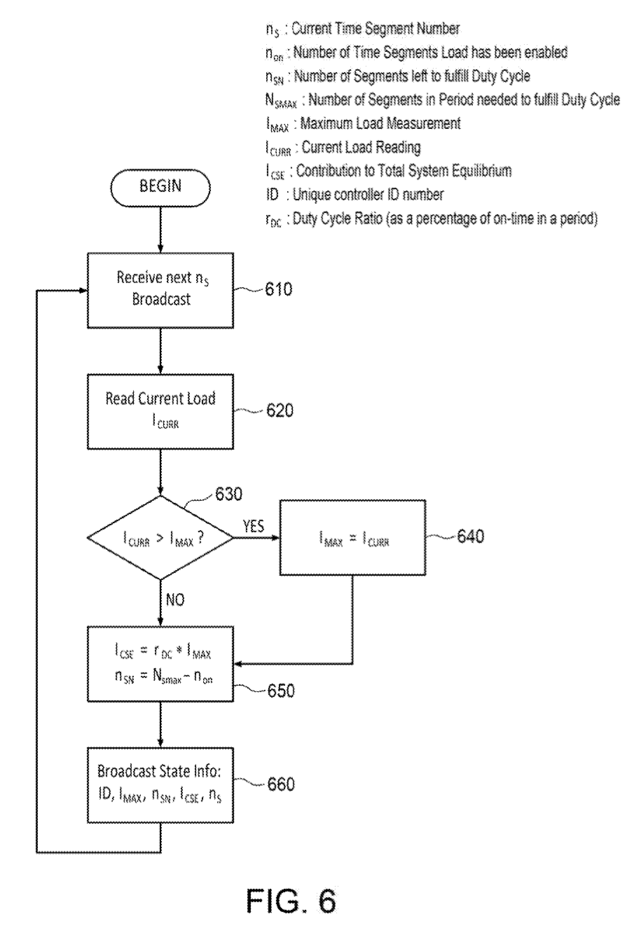

Each controller in a load group also reports its state to other controllers with which it communicates including those in its load group and those in the frequency regulation group. A set of instructions or an algorithm for this process is shown in FIG. 6, which begins by the controller receiving the current segment number (nₛ) broadcast (step 610). A current load reading (I_{CURR}) is then established (step 620). If I_{CURR} is greater than the maximum load measurement (I_{MAX}) (step 630) then I_{MAX} is set to I_{CURR} (step 640). Then the contribution to the total system equilibrium (I_{CSE}) is calculated as the duty cycle ratio (r_{d}) multiplied by I_{MAX}; and the number of segments left to fulfill the duty cycle (n_{SN}) is determined as the number of segments in the period needed to fulfill the duty cycle (N_{SMAX}) less the number of time segments the load has been enabled (nₒₙ) (step 650). The controller then broadcasts its current state information (step 660), including its unique controller identification number (ID); I_{MAX}, ns_{N}, I_{CSE}, and nₛ to the other controllers in its group of loads and in the frequency regulation group.

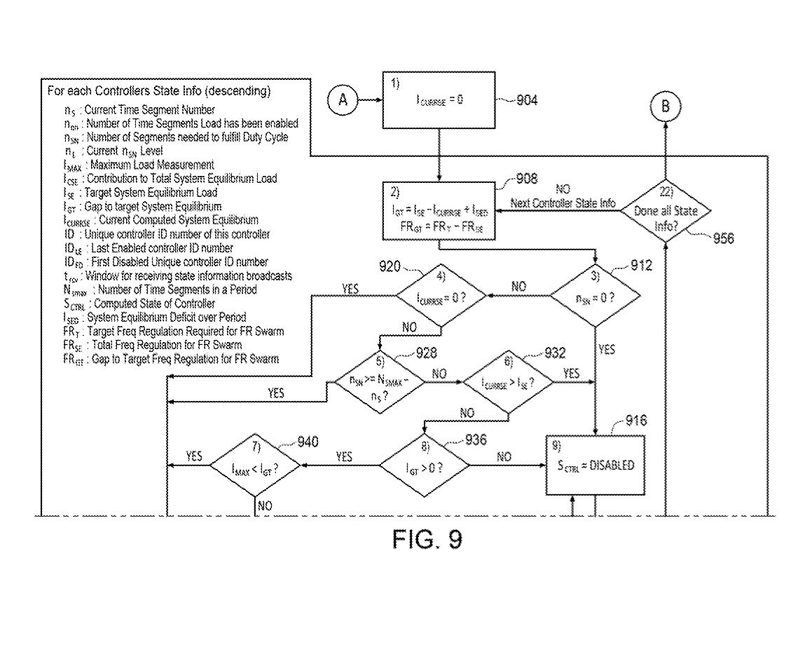

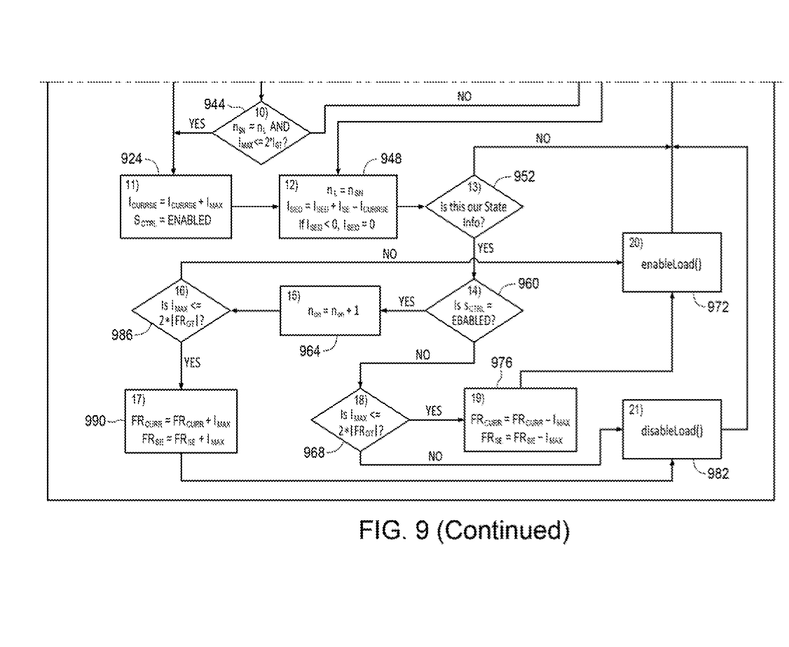

Each time segment is broken down into four logical sub-segments. The first sub-segment is used to receive synchronization information. This takes a small fraction of the total segment. The second sub-segment is used by each controller to broadcast (and receive) state information from every other controller. This also requires small fraction of the entire segment. The third sub-segment is used by each controller to decide whether its load should be enabled, as shown in FIG. 9, and again requires a short part of the total segment. The last sub-segment is a “do nothing” segment wherein the load, if enabled by the controller, functions as if the controller were not present, and if disabled by the controller, remains turned off

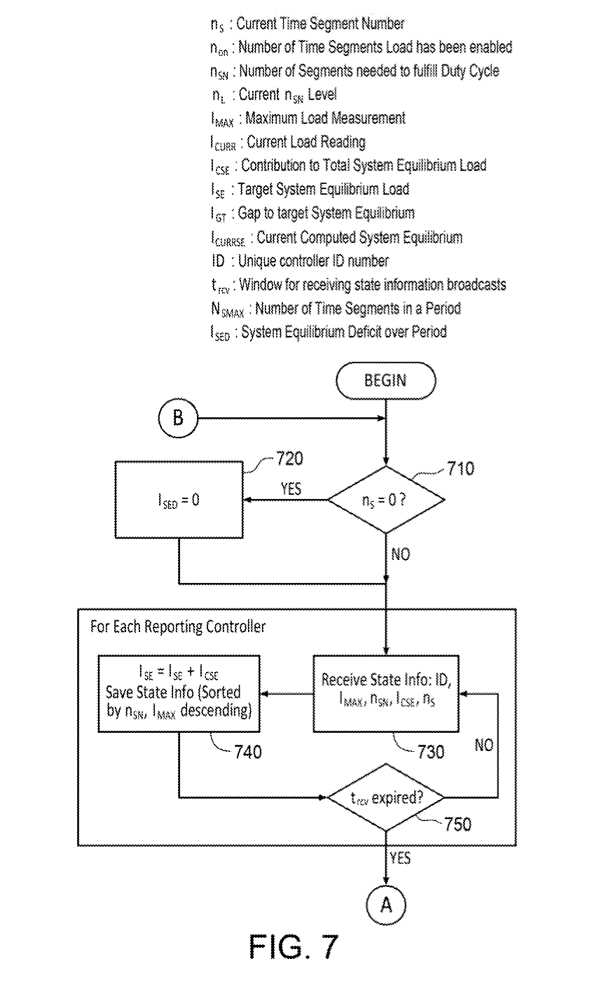

The state information receipt sub-segment, a set of instructions or an algorithm for which is shown in FIG. 7, begins with the determination if nₛ=0 (step 710). If ns=0 then the system equilibrium deficit over period (I_{SED}) is also set to 0 (step 720). Then for each reporting controller (i.e. controller sending state information), state information is received (step 730), including I_{MAX}, N_{SN}, I_{CSE}, and nₛ. I_{SE} is then increased by I_{CSE}, and the state information is saved and is sorted in order of n_{SN}, I_{MAX} descending (step 740). The controller then determines if the time window for receiving state information broadcasts (t_{rcv}) has expired (step 750). If it has not, more state information is received at step 730. If it has expired the load enablement sub-segment begins as shown in FIG. 9 (designated as A).

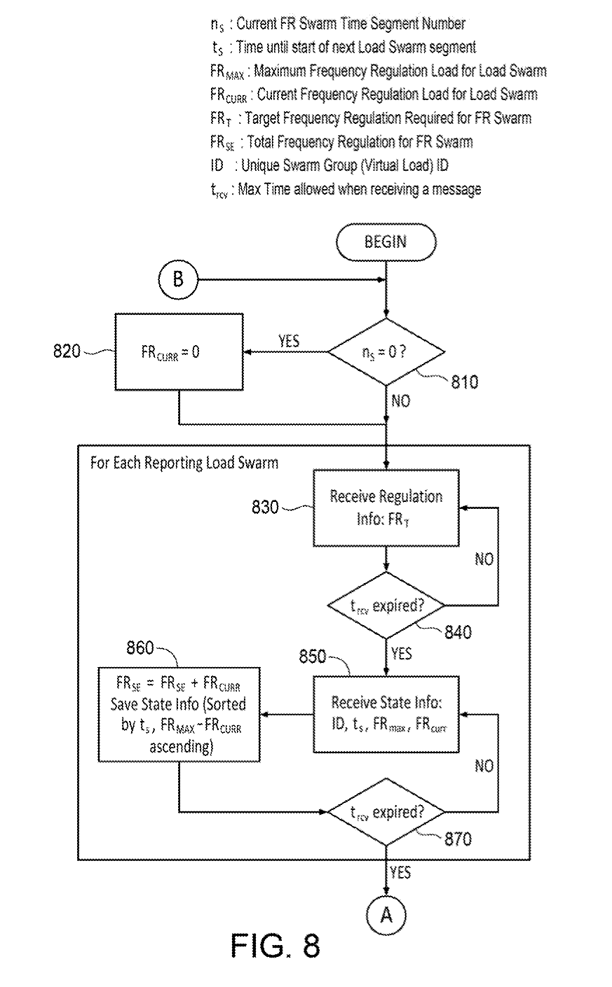

Each group of loads in the frequency regulation group must also make a decision. A set of instructions or algorithm for this process is shown in FIG. 8. A determination is made as to whether nₛ=0 (step 810). If it does then FR_{CURR} is set to 0 (step 820). Then each load group receives the target frequency regulation required for the frequency regulation group (FR_{T}) (step 830). The load group then determines if r_{rcv} has expired (step 840). If not, the load group receives or waits to receive more information (step 830). If t_{crv} has expired the state information is received including ID, tₛ, FR_{MAX} and FR_{CURR} (step 850). The total frequency regulation for the frequency regulation group (FR_{SE}) is then increased by FR_{CURR}; and the state information is saved and is sorted in order of tₛ, FR_{MAX}−FR_{CURR} ascending (step 860). The load group again determines if tcv has expired (step 870) and if not, receives additional state information (step 850). If t_{CV} has expired, the load enablement sub-segment begins as shown in FIG. 9 (designated as A). Note in this figure the word “swarm” is used as synonymous with “group”.

The frequency regulation group is informed of the target frequency regulation from an external source, such as AGC Aggregator/Frequency monitor 200 as shown in FIG. 2. Also the state information received by each load group corresponds to the state information received by each controller, in particular the state information for each load group contains a load group's unique ID (instead of a controller's ID), the time until the next segment (instead of a controller's need), the load group's maximum frequency regulation load (instead of a controller's maximum load), the load group's current frequency regulation load (instead of a controller's contribution to system equilibrium, i.e. its current duty cycle multiplied by its maximum load).

The frequency regulation system equilibrium, which is the value which the frequency regulation group attempts to match, corresponds to the system equilibrium of a load group in that it is the sum of all system equilibrium points of the participating nodes in the group. In the case of the frequency regulation groups, it is the sum of each load group's frequency. In the case of a load group, it is the sum of each controller's contribution.

FIG. 9 shows a set of instructions or algorithm taken during the third sub-segment, in which each controller determines whether to enable an attached load. Initially variables are initialized, and specifically the current computed system equilibrium (I_{CURSE}) is set to 0 (step 904).

For each received controller state information in descending order, the gap to the target system equilibrium (I_{GT}) is calculated by subtracting I_{CURRSE} from I_{SE} and then adding I_{SED}; and the gap to frequency regulation target system equilibrium (FR_{GT}) is calculated by subtracting FR_{SE} from FR_{T} (step 908).

The number of segments need to fulfill the duty cycle (n_{SN}) is then compared to 0 (step 912). If the value of n_{SN} is 0, the load has no need to operate, so the computed state of the controller (S_{CTRL}) is set to DISABLED (step 916).

The current computer system equilibrium (I_{CURR}) is then compared to zero (step 920). If I_{CURRSE} is 0, it is increased by the value of I_{MAX}, and S_{CTRL} is set to ENABLE (step 924). This will occur in situations where no load has been enabled yet, so the assumption is made to enable the first load. Since the given controller will be enabled, we should assume that the cumulative system load will increase by that controller's maximum recorded load. The controller flag, S_{CTRL}, is set to enable the controller.

If I_{CURRSE} is not equal to 0, n_{SN} is then compared to N_{SMAX}−nₛ (step 928). If n_{SN} is greater or equal to the value of N_{SMAX}−ns then I_{CURRSE} is increased by I_{MAX} and S_{CTRL} is enabled (step 924). A load meeting this condition is enabled as its need exceeds the number of segments remaining in this period, therefore it is running out of time to achieve its duty cycle requirement.

If n_{SN} is not greater or equal to the value of N_{SMAX}−ns then I_{CURRSE} is compared to I_{SE}. (step 932) If I_{CURRSE} is greater than I_{SE}, then the target system equilibrium has been reached and the load will be disabled (step 916). If I_{CURRSE} is equal to or less than I_{SE}, then a determination is made whether I_{GT}>0 (step 936). If I_{GT} is zero or less then no gap to target system equilibrium remains and S_{CTRL} is set to DISABLED (step 916).

If IGT is greater than 0, it is determined if I_{MAX} is less than I_{GT} (step 940). If I_{MAX} is less than I_{GT} then I_{CURRSE} is increased by I_{MAX} and S_{CTRL} is set to ENABLED (step 924). In this case, enabling the load helps close (but does not exceed) the gap to the target system equilibrium.

If I_{MAX} is greater than or equal to I_{GT}, then a determination is made if n_{SN} equals n_{L} and if I_{MAX} is less than or equal to twice the value of IGT (step 944). If both of these conditions are met, I_{CURRSE} is increased by I_{MAX} and S_{CTRL} is set to ENABLED (step 924). If either of these conditions are not met, S_{CTRL} is set to DISABLED (step 916). The first part of the condition deals with identifying whether the given controller is of the same need as the previous controller that was processed, i.e. they are of a common need level. This provides that only the first condition is checked on loads with the same need level. For example, if it is a matter of deciding whether to add yet another load with the same need level as previously examined loads (of the same need), then all such loads have the same need to be enabled. If one load is of a lesser need than the others, it should not be able to overshoot the target system equilibrium until higher priority loads have been considered for enabling. The second condition provides that while this particular controller's maximum load would exceed the target system equilibrium, the result would be closer to the target system equilibrium than if the load was not enabled. These conditions provide for a more pessimistic scheduling method wherein the target system equilibrium is exceeded at the first opportunity if the excess is less than the undervalue for loads of the same need level. This serves to avoid cases in which at the last segment, all controllers determine that all loads must be enabled (thereby potentially causing a peak load value equal to the theoretical maximum).

Once the S_{CTRL} value has been set to ENABLED (step 924) or DISABLED (step 916), then n_{L} is set to n_{SN}, and I_{SED} is set to I_{SED} plus I_{SE} and subtracting I_{CURRSE}. If the resultant I_{SED} is less than 0, it is set to equal 0 (step 948). This sets the “current” need level to be the need of the current load, so that the next pass through the process will include the “current” need level. Also the new deficit is set for the controller if it has undershot the target system equilibrium. As the system is adjusting load enablements to deal with a deficit at the earliest possible opportunity, a negative deficit can be erased.

The process then determines if the state information is for the controller conducting the processing (step 952). If this iteration through the process is the information for the current controller, some processing is done to facilitate frequency regulation and whether to enable or disable the load connected to the controller. If the iteration is not for the current controller, then a determination is made whether all of the state information has been processed (step 956). If not the process returns to step 908 and proceeds through the process for the next controller state information in order. If yes the process returns to the beginning of the processes shown in FIGS. 7 and 8.

If the state information is for the current controller, then the S_{CTRL} setting is checked to see if it is ENABLED (step 960). If the value is set to ENABLED, it is then determined if the frequency regulation conditions allow the load to be enabled. If the value is enabled, the number of time segments the loads has been enabled (nₒₙ) is increased by one (step 964). Even if the decision is made later to disable the controller for frequency regulation reasons (despite the system equilibrium calculations indicating it should be enabled), for the purposes of demand management, the system assumes the load has been turned on, so its need will consequently decrease.

The next step is to determine if I_{MAX} is less than or equal to twice the absolute value of FR_{GT} (step 986) to test if by disabling the load, the system would be closer to the frequency regulation target. If this condition is not met, the load is enabled (step 972), and a determination if there is additional state information for processing made (step 956).

If the above condition is not met, FR_{CURR} is set to FR_{CURR}+I_{MAX}, and FR_{SE} is set to FR_{SE}+I_{MAX} (step 990). This updates the current level of regulation for the load group and the current level of regulation for the frequency regulation group taking into account the disablement of this load. The load is then disabled (step 982).

If SCTRL is set to disabled at step 960, then a determination is made as to whether IMAX is less than or equal to twice the absolute value of FRGT (step 968). This determines that if loads that are to be disabled would bring the frequency regulation group closer to the frequency regulation target they should be enabled. If this condition is not met the load is disabled (step 982).

If the above condition is met then FR_{CURR} is set to FR_{CURR}−I_{MAX}, and FR_{SE} is set to FR_{SE} minus I_{MAX} (step 976) to update the current level of frequency regulation for the load group and the current level of frequency regulation for the frequency regulation group taking into account the enablement of the load. The load is then enabled (step 972).

Further and in addition to the disclosure provided above, it will be readily apparent to one of ordinary skill in the art that the various processes and methods described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth M., and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, and a combination of any of the above). Each of the devices may themselves comprise computers or other computing devices, such as those based on the Intel® Pentium® or Centrino™ processor, that are adapted to communicate with the computer. Any number and type of devices may be in communication with the computer.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

I claim:

1. A method for managing a group of energy consuming loads for frequency regulation comprising a plurality of groups of loads, the method comprising:
generating a set of load state data from each of the loads in each of the groups of loads, wherein at least one of the loads in each of the group of loads is comprised of a discretionary load, wherein each of the loads in each of the group of loads has a duty cycle, and wherein the duty cycle for at least one of the discretionary loads in each group of loads is less than 100 percent;
generating a set of group of loads data from each of the group of loads;
making an enablement state decision for each of the loads using the sets of load state data from the loads and the group of loads data from the groups of loads, wherein each of the enablement state decisions reflects an enablement state of a corresponding load in the group of loads, wherein the enablement state is either a load enabled state or a load disabled state, wherein the load enabled state is a state where the corresponding load is capable of operating even when the corresponding load is not actually operating, and wherein the load disabled state is a state where the corresponding load is not capable of operating; and
implementing the enablement state decisions.

2. The method as claimed in claim 1 wherein the enablement state decisions are made with a goal of achieving a frequency regulation for the groups of loads.

3. The method as claimed in claim 2 wherein the groups of loads have a target frequency regulation.

4. The method as claimed in claim 3 wherein the enablement state decisions are constrained by the variation caused by a load in a load enabled state or a load disabled state from the frequency regulation target.

5. The method as claimed in claim 1 wherein the enablement state decisions for loads in a group of loads are made in a decision making sequence.

6. The method as claimed in claim 5 wherein each of the loads in a group of loads has an impact on a level of frequency regulation for the group of loads and wherein the decision making sequence is dependent upon the impact on the level of frequency regulation.

7. The method as claimed in claim 1, further comprising repeating the steps in accordance with a schedule.

8. The method as claimed in claim 7 wherein the schedule is comprised of at least one segment.

9. The method as claimed in claim 8 wherein the segment is comprised of a plurality of sub-segments.

10. The method as claimed in claim 9 wherein one of the sub-segments is used to receive load state data and groups of loads data.

11. The method as claimed in claim 9 wherein one of the sub-segments is used to broadcast load state data and group of loads data.

12. The method as claimed in claim 9 wherein one of the sub-segments is used to make the enablement decision.

13. The method as claimed in claim 1 wherein the set of group of loads data comprises a time until the loads in the group of loads will make the enablement state decision.

14. A method for managing an energy consuming load for frequency regulation in a group of energy consuming loads, comprising the load and a plurality of other loads, and comprising a plurality of groups of loads, the method comprising:
(a) receiving a set of load state data from the load, wherein the load is comprised of a discretionary load, wherein the load has a duty cycle and wherein the duty cycle for the load is less than 100 percent;
(b) receiving a set of group of loads data from each of the group of loads;
(b) compiling the set of load state data generated from the load with sets of load state data generated from the other loads and with sets of group of loads data generated from the groups of loads;
(c) making an enablement state decision for the load using the compiled sets of load state data and group of loads data, wherein the enablement state decision reflects an enablement state of the load, wherein the enablement state is either a load enabled state or a load disabled state, wherein the load enabled state is a state where the load is capable of operating even when the load is not actually operating, and wherein the load disabled state is a state where the load is not capable of operating; and
(d) implementing the enablement state decision for the load.

15. The method as claimed in claim 14 wherein the enablement state decisions are made with a goal of achieving a frequency regulation for the groups of loads.

16. The method as claimed in claim 15 wherein the plurality of groups of loads have a target frequency regulation.

17. The method as claimed in claim 16 wherein the enablement state decisions are constrained by the variation caused by a load in a load enabled state or a load disabled state from the frequency regulation target.

18. The method as claimed in claim 14 wherein the enablement state decisions for loads in a group of loads are made in a decision making sequence.

19. The method as claimed in claim 18 wherein each of the loads in a group of loads has an impact on a level of frequency regulation for the group of loads and wherein the decision making sequence is dependent upon the impact on the level of frequency regulation.

20. The method as claimed in claim 14, further comprising repeating the steps in accordance with a schedule.

21. The method as claimed in claim 20 wherein the schedule comprises of at least one segment.

22. The method as claimed in claim 21 wherein the segment comprises a plurality of sub-segments.

23. The method as claimed in claim 22 wherein one of the sub-segments is used to receive load state data and groups of loads data.

24. The method as claimed in claim 22 wherein one of the sub-segments is used to broadcast load state data and group of loads data.

25. The method as claimed in claim 22 wherein one of the sub-segments is used to make the enablement decision.

26. The method as claimed in claim 14 wherein the set of group of loads data comprises a time until the loads in the group of loads will make the enablement state decision.

27. A method for managing a group of energy consuming loads for frequency regulation comprising a plurality of groups of loads, the method comprising:
generating a set of load state data from each of the loads in each of the groups of loads, wherein at least one of the loads in the group of loads is comprised of a discretionary load, wherein each of the loads in the group of loads has a duty cycle, and wherein the duty cycle for at least one of the discretionary loads is less than 100 percent;
generating a set of group of loads data from each of the group of loads;
making an enablement state decision for each of the loads using the sets of load state data from the loads and the set of group of loads data from the groups of loads, wherein each of the enablement state decisions reflects an enablement state of a corresponding load in a group of loads and a state of a group of loads from the plurality of groups of loads, wherein the enablement state is either a load enabled state or a load disabled state, wherein the load enabled state is a state where the corresponding load is capable of operating even when the corresponding load is not actually operating, and wherein the load disabled state is a state where the corresponding load is not capable of operating; and
implementing the enablement state decisions.

28. A computer readable nontransitory medium providing computer readable instructions for directing a processor to make an enablement state decision reflecting an enablement state of an energy consuming load in a group of energy consuming loads comprising the load and a plurality of other loads, the group of loads in a plurality of groups of loads, wherein the enablement state is either a load enabled state or a load disabled state, wherein the load enabled state is a state where the load is capable of operating even when the load is not actually operating, and wherein the load disabled state is a state where the load is not capable of operating, the instructions comprising:
generating a set of load state data from the load;
generating a set of group of loads state data from the group of loads;
compiling the set of load state data from the load with sets of load state data from the other loads and with the set of group of loads data and with the other groups of loads; and
processing the compiled sets of load state data in order to make the enablement state decision.

29. A computer program product comprising computer readable instructions for directing a processor to make an enablement state decision reflecting an enablement state of an energy consuming load in a group of energy consuming loads comprising the load and a plurality of other loads, the group of loads in a plurality of groups of loads, wherein the enablement state is either a load enabled state or a load disabled state, wherein the load enabled state is a state where the load is capable of operating even when the load is not actually operating, and wherein the load disabled state is a state where the load is not capable of operating, the instructions comprising:
generating a set of load state data from the load;
generating a set of group of loads state data from the group of loads;
compiling the set of load state data from the load with sets of load state data from the other loads and with the set of group of loads data and with the other groups of loads; and
processing the compiled sets of load state data in order to make the enablement state decision.

30. A controller of an electrical load, the load within a group of loads, the group of loads within a group of groups of loads, the controller configured to make an enablement decision regarding the load based on a set of data received relating to the state of a plurality of loads with the group of loads, and a set of data received relating to the other groups of loads; the enablement decision including an assessment of the impact of the load on a target frequency regulation.
